(19) United States
(12) Patent Application Publication
(10) Pub. No.: US 2017/0361784 A1
(43) Pub. Date: Dec. 21, 2017

(54) VEHICLE TRIM ACCESSORY AND METHOD OF TRIMMING A VEHICLE

(71) Applicant: JEFFREY S. PATTON, MECHANICSVILLE, VA (US)

(72) Inventor: JEFFREY S. PATTON, MECHANICSVILLE, VA (US)

(21) Appl. No.: 15/621,174

(22) Filed: Jun. 13, 2017

Related U.S. Application Data
(60) Provisional application No. 62/352,325, filed on Jun. 20, 2016.

(51) Int. Cl. B60R 13/04; F16B 5/02

(52) U.S. Cl. CPC B60R 13/04; F16B 5/02

(57) ABSTRACT

A vehicle trim accessory vehicle trim accessory comprises an elongated central portion having first and second opposing long edges, an elongated mounting flange portion having first and second opposing long edges, an elongated first curved portion connecting the first long edge of the central portion and the first long edge of the mounting flange portion, an elongated free flange portion having first and second opposing long edges, and an elongated second curved portion connecting the second long edge of the central portion and the first long edge of the free flange portion. The size and radius of the curved portion is selected to create a desired angle and distance between the central portion and the mounting flange portion and therefore between the central portion and the pinch rail. Both the first and second curved portions curve toward a same side of the central portion.

### CROSS-REFERENCE TO RELATED APPLICATIONS

This application claims priority to U.S. Provisional Application Ser. No. 62/352,325, filed Jun. 20, 2016, the contents of which are incorporated herein by reference in its entirety.

### FIELD OF THE INVENTION

The present invention relates to vehicle trim accessories.

### BACKGROUND OF THE DISCLOSURE

In many motor vehicles, the floor panel and the side panels are formed from separate pieces of sheet metal. The junction of the floor panel and the side panel is termed the pinch rail or pinch weld. As seen in FIG. 3, the side of the floor panel 30 ends in a downward projecting flange 34. Similarly, the bottom of the side panel ends in a downward projecting flange 36. Flanges 34 and 36 are welded together to form pinch rail 38. The pinch rail typically runs from behind the front wheel well to before the rear tire well underneath the doors on each side of the vehicle. Typically, several through-holes are formed in the pinch rails during manufacture of the vehicle. Factory of aftermarket step rails and the like are often affixed to the pinch rail of a vehicle.

The pinch rail is readily visible when looking at a vehicle. Many people consider the pinch rail to have an unfinished and therefore unattractive look.

### BRIEF SUMMARY OF THE DISCLOSURE

In one embodiment of the invention, a vehicle trim accessory an elongated central portion having first and second opposing long edges, an elongated mounting flange portion having first and second opposing long edges, an elongated first curved portion connecting the first long edge of the central portion and the first long edge of the mounting flange portion, an elongated free flange portion having first and second opposing long edges, and an elongated second curved portion connecting the second long edge of the central portion and the first long edge of the free flange portion. The mounting flange portion defines a plurality of mounting holes adapted to affix the mounting flange portion and thereby the vehicle trim accessory to a pinch rail of a motor vehicle. The size and radius of the first curved portion are selected to create a desired angle and distance between the central portion and the mounting flange portion and therefore between the central portion and the pinch rail when the mounting flange portion is affixed to the pinch rail. Both the first and second curved portions curve toward a same side of the central portion.

The free flange portion may be substantially parallel to the central portion.

The central portion, the mounting flange portion, the first curved portion, the free flange portion, and the second curved portion may all form a unitary structure.

The central portion may be substantially planar. The mounting flange portion may be substantially planar. The free flange portion may be substantially planar.

The central portion, the mounting flange portion, the first curved portion, the free flange portion, and the second curved portion may all be a same length. The length may be selected to obstruct a view of at least a portion of the pinch rail when the vehicle trim accessory is affixed to the pinch rail.

In alternative embodiments of the invention, a method of trimming a vehicle comprises:

(a) obtaining a vehicle trim accessory comprising: an elongated central portion having first and second opposing long edges; an elongated mounting flange portion having first and second opposing long edges; and an elongated first curved portion connecting the first long edge of the central portion and the first long edge of the mounting flange portion, such that an acute angle is defined between the central portion and the mounting flange portion; (b) positioning the vehicle trim accessory such that the mounting flange portion is against a pinch rail of a motor vehicle with its second edge pointed upward and such that the central portion angles upward and outward toward a side panel or rocker panel of the motor vehicle; and (c) affixing the mounting flange portion to the pinch rail.

The vehicle trim accessory may further comprise an elongated free flange portion having first and second opposing long edges and an elongated second curved portion connecting the second long edge of the central portion and the first long edge of the free flange portion. Both the first and second curved portions may curve toward a same side of the central portion. The vehicle trim accessory may be positioned such that either the free flange portion or the second curved portion or both contact the side panel or rocker panel.

The mounting flange portion may define a plurality of mounting holes. The positioning step may comprise aligning two or more of the plurality of mounting holes in the mounting flange portion with corresponding ones of mounting holes defined in the pinch rail and securing a fastening device in each pair of aligned holes.

The positioning step may comprise positioning the vehicle trim accessory such that the mounting flange portion is against a medial side of a pinch rail of a motor vehicle.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a reverse perspective view of a vehicle trim accessory, in accordance with embodiments of the present invention.

FIG. 2 is an end view of the vehicle trim accessory of FIG. 1.

FIG. 3 is a cross-sectional view of the vehicle trim accessory of FIG. 1 mounted to a vehicle pinch rail.

FIG. 4 is a perspective view of the vehicle trim accessory of FIG. 1 mounted to a vehicle.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

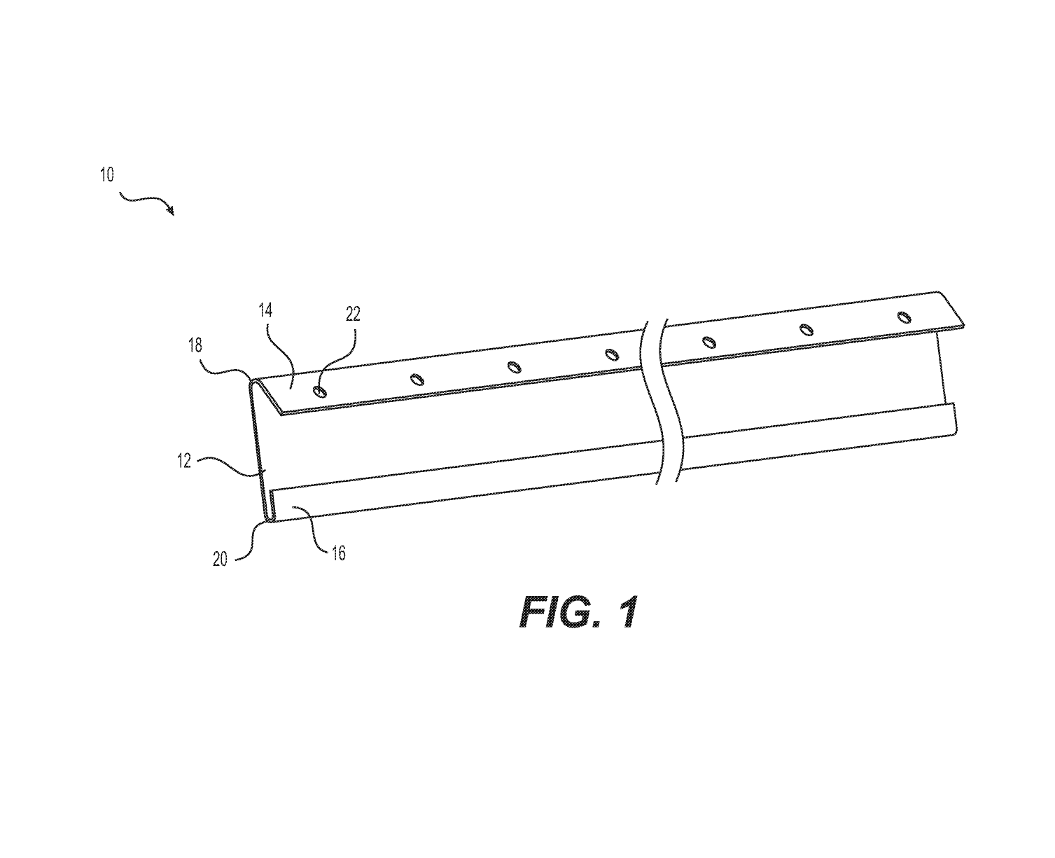

Embodiments of the invention are directed to vehicle trim accessories, specifically vehicle trim accessories for at least partly covering and/or hiding a vehicle pinch rail in a decorative manner. Referring now to FIGS. 1-4, a vehicle trim accessory 10 is illustrated in accordance with embodiments of the invention. The vehicle trim accessory 10 comprises an elongated rigid or semi-rigid piece. The vehicle trim accessory 10 may be constructed out of any suitable durable, rigid or semi-rigid material or combination of materials, such as aluminum, stainless steel, or any suitable plastic.

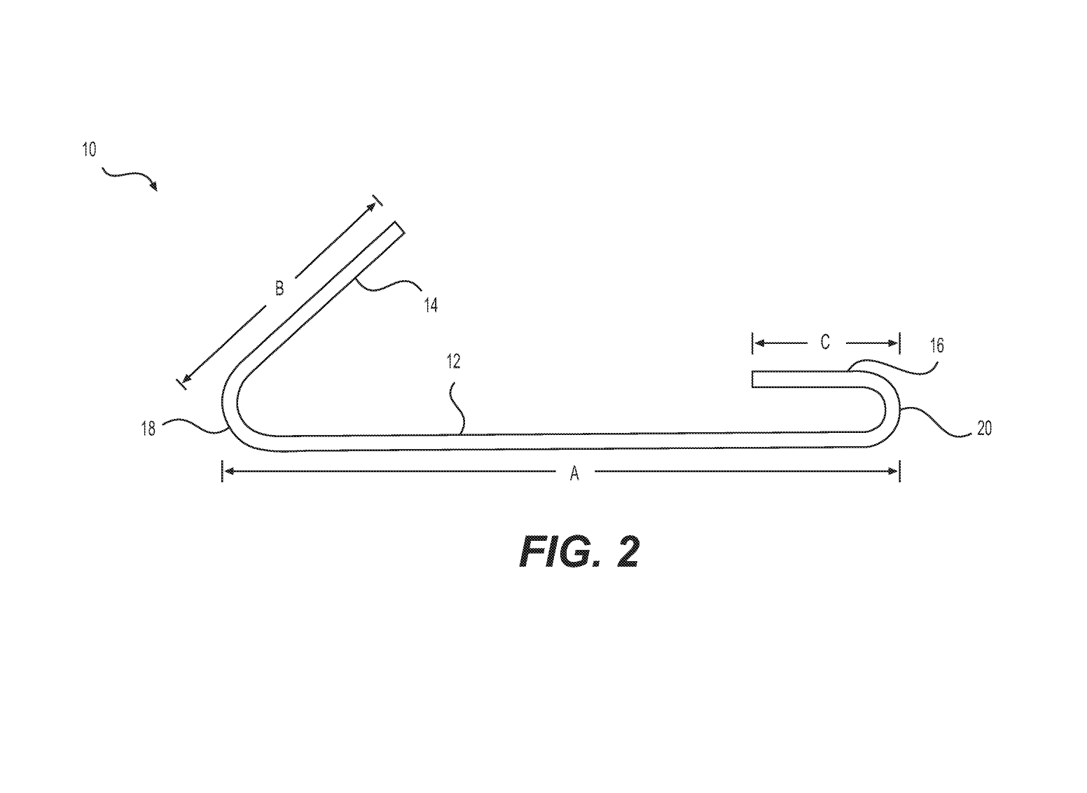

In one embodiment of the invention, the vehicle trim accessory 10 is constructed of 16-gauge aluminum flat stock that is 4.5 inches wide and any desirable length (as discussed further below). As seen in the figures, two bends are made in the flat stock (one bend along each long side) to form the vehicle trim accessory 10. In this regard, vehicle trim accessory 10 is a unitary structure without any seams, connection points, or the like which may collect dirt and debris. A first bend 18 is made in the flat stock to form a first flange 14, and a second bend 20 is made in the opposite side of the flat stock to form a second flange 16. A main body 12 is formed between the first and second bends. The first flange may be termed a “mounting flange,” as it is used to mount the vehicle trim accessory 10 to a vehicle as described below. The second flange may be termed a “free flange,” as the second flange is not affixed to anything when the vehicle trim accessory 10 is mounted to a vehicle as described below. In one embodiment of the invention, first bend 18 has a radius of about 5/16 inch, second bend 20 has a radius of about ¼ inch, main body 12 has a width of about 2¾ inches (dimension A in FIG. 2), first flange 14 has a width of about 1¼ inches (dimension B in FIG. 2), and second flange 16 has a width of about ½ inch (dimension C in FIG. 2) (all of the dimensions may vary as needed).

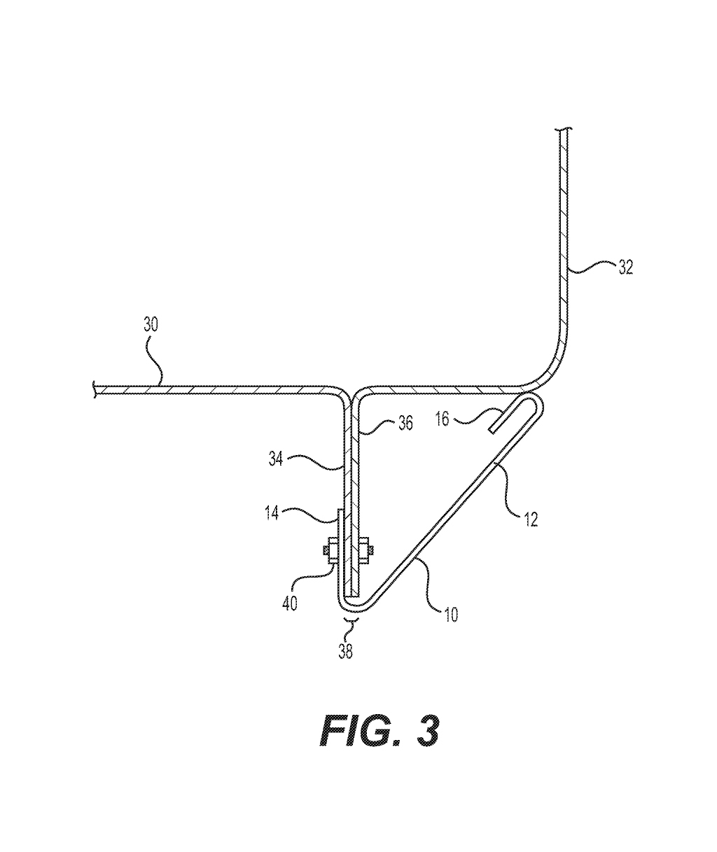

Main body 12, first flange 14, and second flange 16 are all typically (but not necessarily) substantially planar (not including the first and second bends). The main body 12 may alternatively be non-planar, such as having an outward curvature. The width of the first flange 14 and the radius and angle of the first bend 18 are typically selected such that the first flange can be affixed to the pinch rail as described below and such that there is enough room for the fastener used to affix the first flange to the pinch rail. The width of the main body 12 and the angle of the first bend 18 are typically selected such that the vehicle trim accessory 10 adequately hides the pinch rail. The angle between the main body 12 and the first flange 14 is typically in the range of 30-45 (or possibly up to 60) degrees (i.e., from the flat stock, the first flange 14 has been bent 135-150 (or possibly as little as 120) degrees). The angle between the main body 12 and the second flange 16 is typically zero degrees (i.e., from the flat stock, the second flange 16 has been bent 180 degrees), that is, the main body 12 and the second flange are typically substantially parallel, as seen in FIGS. 2 and 3. However, the angle between the main body 12 and the second flange 16 may be greater than zero degrees, if desired. For example, the angle between the main body 12 and the second flange 16 may be as much as 50 degrees (i.e., from the flat stock, the second flange 16 may be bent 130 degrees). If the main body 12 and the second flange are not parallel, the maximum desired angle therebetween would typically be selected such that the point of contact between the second flange 16 and the horizontal portion of the side panel/rocker panel 32 is either the second bend 20 or the flat part of second flange 16. It is typically not desirable for the free end of the second flange 16 to contact the side panel/rocker panel 32, as the free end of the second flange 16 may scratch or otherwise damage the side panel/rocker panel 32.

One or more mounting holes 22 may be defined in the first flange 14 to enable the vehicle trim accessory 10 to be mounted to a vehicle pinch rail as described below. The mounting holes may be defined during manufacture of the vehicle trim accessory (the location and spacing of the holes being selected to correspond to mounting holes defined in the pinch rail of one or more specific vehicle make/model) or just prior to mounting (such that the location and spacing of the holes can be made to correspond to mounting holes defined in the pinch rail of any vehicle make/mode).

Referring now to FIG. 3, a cross-sectional view of the vehicle trim accessory of FIG. 1 mounted to a vehicle pinch rail is illustrated. As seen in FIG. 3, the vehicle trim accessory 10 is affixed to the pinch rail such that the main body 12 forms a generally triangular shape with the pinch rail 38 and a horizontal portion of the side panel/rocker panel 32. In this regard, the main body 12 of the vehicle trim accessory 10 hides the pinch rail 38. The vehicle trim accessory 10 not only hides the pinch rail from sight, but the vehicle trim accessory 10 may itself may be decorative, such as by being painted to match the vehicle color.

To mount the vehicle trim accessory 10 to the pinch rail 38, the first flange 14 is placed against the pinch rail 38. FIG. 3 illustrates the first flange 14 being placed against the medial (inward) surface of the pinch rail 38; however the first flange 14 could be placed against the lateral (outward) surface of the pinch rail 38 if desired. Existing mounting holes 22 (if present and correctly positioned) are aligned with corresponding holes in the pinch rail, or if needed new mounting holes are created in the vehicle trim accessory 10 to align with corresponding holes in the pinch rail. Any suitable fasteners 40 (such as bolts or self-tapping screws) are used to secure the first flange 14 to the pinch rail 38. The second bend 20 typically contacts the side panel/rocker panel 32 (it is possible that, in some circumstances, the second flange 16 could contact the side panel/rocker panel 32, or the contact point could be where the second flange 16 and the second bend 20 meet). Having the second bend (rather than just a planar edge) provides better contact between the vehicle trim accessory 10 and the side panel/rocker panel 32 and helps prevent water, debris, etc. from getting behind the vehicle trim accessory 10. However, in alternative embodiments of the invention (not illustrated) the second bend and second flange may be omitted leaving a planar free edge of the main body (i.e., the edge opposite the first flange). In other alternative embodiments, the second flange may be omitted. In such alternative embodiments, the second bend may curve around to or nearly to itself or to an interior surface of the main body, thereby forming a partial or complete cylinder.

The vehicle trim accessory 10 may be constructed in any desirable length or lengths. For example, the vehicle trim accessory 10 may be constructed in specific lengths to cover an entire pinch rail for a specific vehicle type. Alternatively the vehicle trim accessory 10 may be constructed long enough to cover an entire pinch rail for many different makes/models of vehicles, such that the vehicle trim accessory 10 is cut down to the desired length for installation on a specific make/model of vehicle. Further, the vehicle trim accessory 10 may be installed on a vehicle on which a step rail (or other accessory) has already been (or is to be) installed on the pinch rail, in which case shorter lengths of the vehicle trim accessory 10 will be needed to mount fore and aft of and between the attachment points of the step rail. The vehicle trim accessory 10 may be manufactured in such shorter lengths, or the vehicle trim accessory 10 may be cut down to the desired shorter lengths.

The vehicle trim accessory 10 may be uncoated or coated (such as with rubber or plastic) and may be unpainted or painted.

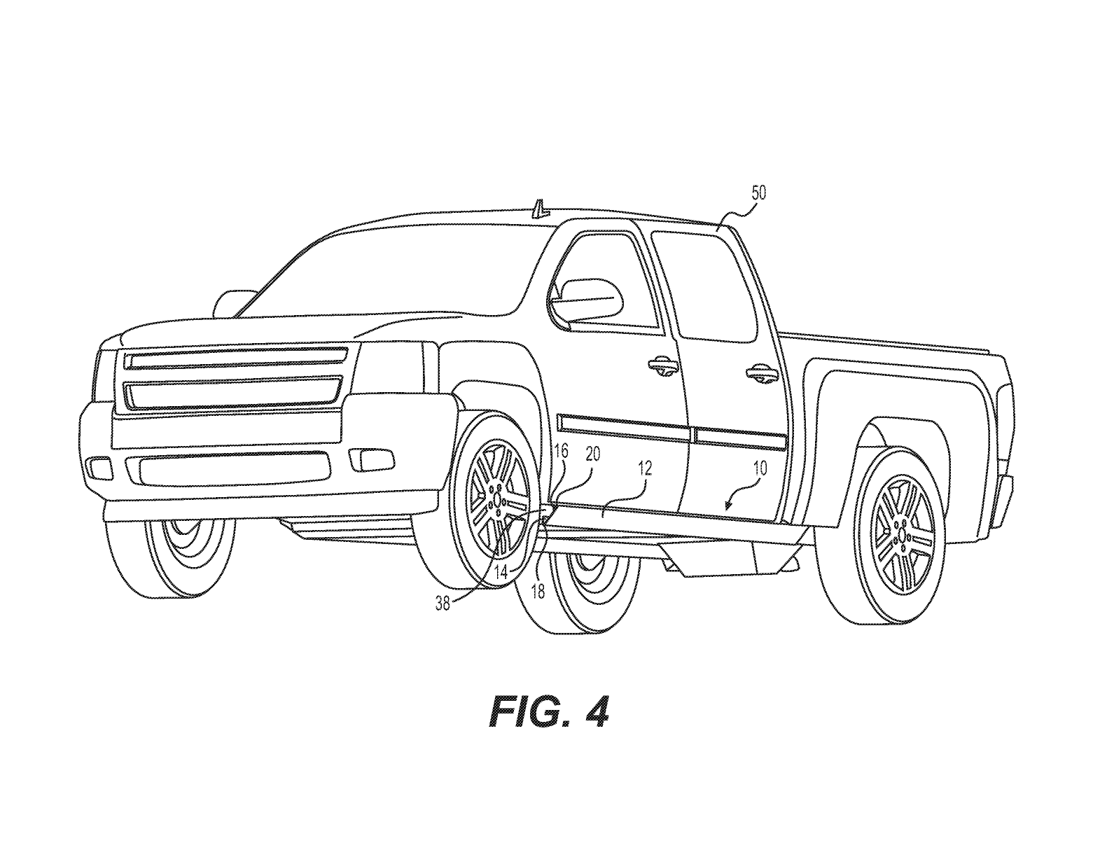

As seen in FIG. 4, when the vehicle trim accessory 10 is affixed to a motor vehicle 50, the vehicle trim accessory 10 obstructs the view of the pinch rail 38 and is visible as a decorative substantially planar, angled trim piece below the rocker panel.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A vehicle trim accessory comprising:
an elongated central portion having first and second opposing long edges;
an elongated mounting flange portion having first and second opposing long edges, the mounting flange portion defining a plurality of mounting holes adapted to affix the mounting flange portion and thereby the vehicle trim accessory to a pinch rail of a motor vehicle;
an elongated first curved portion connecting the first long edge of the central portion and the first long edge of the mounting flange portion, the size and radius of the first curved portion selected to create a desired angle and distance between the central portion and the mounting flange portion and therefore between the central portion and the pinch rail when the mounting flange portion is affixed to the pinch rail;
an elongated free flange portion having first and second opposing long edges; and
an elongated second curved portion connecting the second long edge of the central portion and the first long edge of the free flange portion;
wherein both the first and second curved portions curve toward a same side of the central portion.

2. The vehicle trim accessory of claim 1, wherein the free flange portion is substantially parallel to the central portion.

3. The vehicle trim accessory of claim 1, wherein the central portion, the mounting flange portion, the first curved portion, the free flange portion, and the second curved portion all form a unitary structure.

4. The vehicle trim accessory of claim 1, wherein the central portion is substantially planar.

5. The vehicle trim accessory of claim 1, wherein the mounting flange portion is substantially planar.

6. The vehicle trim accessory of claim 1, wherein the free flange portion is substantially planar.

7. The vehicle trim accessory of claim 1, wherein the central portion, the mounting flange portion, the first curved portion, the free flange portion, and the second curved portion are all a same length; and
wherein the length is selected to obstruct a view of at least a portion of the pinch rail when the vehicle trim accessory is affixed to the pinch rail.

8. A method of trimming a vehicle, the method comprising:
(a) obtaining a vehicle trim accessory comprising:
an elongated central portion having first and second opposing long edges;
an elongated mounting flange portion having first and second opposing long edges; and
an elongated first curved portion connecting the first long edge of the central portion and the first long edge of the mounting flange portion, such that an acute angle is defined between the central portion and the mounting flange portion;
(b) positioning the vehicle trim accessory such that the mounting flange portion is against a pinch rail of a motor vehicle with its second edge pointed upward and such that the central portion angles upward and outward toward a side panel or rocker panel of the motor vehicle; and
(c) affixing the mounting flange portion to the pinch rail.

9. The method of claim 8, wherein the vehicle trim accessory further comprises:
an elongated free flange portion having first and second opposing long edges; and
an elongated second curved portion connecting the second long edge of the central portion and the first long edge of the free flange portion;
wherein both the first and second curved portions curve toward a same side of the central portion; and
wherein the vehicle trim accessory is positioned such that either the free flange portion or the second curved portion or both contact the side panel or rocker panel.

10. The method of claim 8, wherein the mounting flange portion defines a plurality of mounting holes; and
wherein the positioning step comprises:
aligning two or more of the plurality of mounting holes in the mounting flange portion with corresponding ones of mounting holes defined in the pinch rail; and
securing a fastening device in each pair of aligned holes.

11. The method of claim 8, wherein the positioning step comprises positioning the vehicle trim accessory such that the mounting flange portion is against a medial side of a pinch rail of a motor vehicle.

12. The method of claim 9, wherein the free flange portion is substantially parallel to the central portion.

13. The method of claim 9, wherein the central portion, the mounting flange portion, the first curved portion, the free flange portion, and the second curved portion all form a unitary structure.

14. The method of claim 8, wherein the central portion is substantially planar.

15. The method of claim 8, wherein the mounting flange portion is substantially planar.

16. The method of claim 9, wherein the free flange portion is substantially planar.

17. The method of claim 9, wherein the central portion, the mounting flange portion, the first curved portion, the free flange portion, and the second curved portion are all a same length; and
wherein the length is selected to obstruct a view of at least a portion of the pinch rail.
